(19) United States
(12) Patent Application Publication
(10) Pub. No.: US 2011/0311941 A1
(43) Pub. Date: Dec. 22, 2011

(54) STENT INCLUDING ELASTIC PART USING FOR SURGICAL OPERATION OF IMPLANT

(76) Inventors: Tae-Kyoung Yi, Seoul (KR); Je-Kyo Jung, Seoul (KR)

(21) Appl. No.: 13/127,088

(22) PCT Filed: Nov. 3, 2008
(86) PCT No.: PCT/KR08/06466

§ 371 Date: May 2, 2011

(30) Foreign Application Priority Data
Nov. 3, 2008 (KR) 10-2008-0108291

(51) Int. Cl. A61C 19/04

(52) U.S. Cl. 433/75

(57) ABSTRACT

A stent for implant surgery is provided. The stent includes a support part surrounding a buccal side, lingual side and occlusal side of at least one tooth, and a treated part having a through hole through which a drill for drilling alveolar bone passes. The support part extends further from a height of a contour of at least one of the buccal side and the lingual side to surround part of an undercut of the tooth. Further, an elastic part which is elastically deformable is attached to the inner surface of each of the buccal side and the lingual side of the support part.

### TECHNICAL FIELD

The present invention relates, in general, to a stent for implant surgery and, more particularly, to a stent for implant surgery which includes a support part surrounding a buccal side, lingual side and occlusal side of at least one tooth, and a treated part having a through hole through which a drill for drilling alveolar bone passes, wherein the support part extends further from a height of a contour of at least one of the buccal side and the lingual side to surround part of an undercut of the tooth, and an elastic part which is elastically deformable is attached to an inner surface of each of the buccal side and the lingual side of the support part.

### BACKGROUND ART

Generally, an implant is a dental prosthesis which can be used instead of a seriously damaged tooth. Implanting is a dental surgical procedure which implants a fixture made of special metal (mainly, titanium or titanium alloy) into a portion of alveolar bone which has lost a tooth so that the fixture adheres to alveolar bone tissue, and puts a crown on the fixture, thus allowing a patient to lead a daily life with an ability to masticate which is almost identical to that of the original tooth, and the implant is an artificial tooth which is implanted through the dental surgical procedure.

When comparing the implanting with a surgical operation using a denture, a bridge and others, the implanting is more advantageous in that it does not impair teeth other than the tooth requiring the surgical operation. Further, the implant has a long life span and is very similar to a natural tooth. The implanting recently appeals to people for these reasons.

The surgical operation of placing the.implant will be described in brief. First, the gum (gingivae) of a patient undergoing the implant surgery is incised to expose the alveolar bone. Subsequently, a position into which the implant is to be inserted is determined on the exposed alveolar bone, and part of the alveolar bone is removed from the position using a drilling tool such as a drill, so that a hole into which the implant is to be inserted is formed. Next, the implant including a fixture and an abutment is embedded into the formed hole, and is covered with the gum. Thereby, the installation of the implant is completed.

Meanwhile, in a general implant surgery which involves the incision of the gum to expose the alveolar bone and the direct drilling of the exposed alveolar bone using a drill or the like, it is difficult to precisely grasp an accurate position and direction in which the drilling work will be conducted, so that an auxiliary device, called a stent, has been used.

Regarding a stent, before the implant surgery, a negative form (of a patient's upper and/or lower jaw is obtained using an impression material such as a rubber material. Afterwards, plaster is poured into the negative form, thus manufacturing a plaster mold in the shape of the patient's upper and/or lower jaw.

Subsequently, the plaster mold is coupled to an artificial articulator, and the temporomandibular joint and maxillary and mandibular teeth which are almost similar to those of the patient are reproduced outside his or her mouth.

Further, after a transparent resin is applied to surround several teeth and a cavity in which a tooth is missing and is then hardened, a through hole is formed in the portion of the cavity in which the tooth is missing and with which the resin is filled, so that the drill for the implant passes through the through hole.

A transparent resin product manufactured through such a process is referred to as a stent. The cavity made to have the same shape as that of the tooth and surrounded with the transparent resin during the manufacture of the stent is applied to real teeth, thus serving as a support part for supporting the entire stent.

Meanwhile, recently, as 3-dimensional image technology has developed, a mold impressing the shape of a patient's upper and/or lower jaw may be manufactured through rapid prototyping (RP) based on 3-dimensional image data, instead of using the plaster mold. This is equivalent to the process of manufacturing the stent for the implant except for the process of making a mold.

When a drilling operation is conducted for a dentulous or edentulous patient using the stent, it is conducted more smoothly compared to the case of conducting the drilling operation without using the stent. However, the stent itself may not maintain its intended position and shakes, so that a dentist must hold the stent with one hand and manipulate the drilling tool with the other hand.

The important reason why the stent secured to the teeth does not maintain its original position is because of the structure of the stent. That is, the close contact between the outer and inner surfaces of the stent is limited due to the height of contour of teeth. FIG. 1 is a view illustrating a conventional stent and teeth covered by the stent, and FIG. 2 is a schematic sectional view taken along line A-A when the stent of FIG. 1 is coupled to the teeth. As shown in FIG. 2, the contact between the undercut U underneath the height of the contour H of the teeth and the inner surface of the stent is insufficient. The reason is because the opening of the stent is slightly larger than the size of the undercut of the real teeth so as to allow the stent to smoothly pass through the height of contour when the stent is fitted over the teeth. If the stent is manufactured without a clearance between the opening of the stent and the undercut, a patient suffers pain when the stent is detachably attached to the teeth. Especially, the surfaces of the teeth or the stent itself may be damaged.

In order to enhance the contact of the stent with the teeth, making the stent out of a resin material having a considerably high elastic modulus may be considered. However, when the stent is made of a resin material having the considerably high elastic modulus, the durability of the stent itself is reduced and it is difficult to maintain a basic shape of an initial manufacturing stage. Moreover, it is difficult for the stent to have the rigidity sufficient for maintaining an original position when the alveolar bone is drilled using the drill which rotates usually at high speeds of about 10,000 RPM and has high torque. Accordingly, it is difficult to adopt a stent made of a resin material having a considerably high elastic modulus.

Therefore, those skilled in the art have understood that a small gap is inevitably required between the undercut U underneath the height of the contour H of the teeth and the inner surface of the stent, in the conventional stent for an implant.

### DISCLOSURE

### Technical Problem

Accordingly, the present invention has been made keeping in mind the above problems occurring in the prior art, and an object of the present invention is to provide a new stent for implant surgery which alleviates pain and prevents the surfaces of teeth or the stent itself from being damaged when the stent for the implant surgery is detachably attached to the teeth, and which enhances the contact between an undercut underneath the height of the contour of the teeth and the inner surface of the stent, and which effectively absorbs vibrations caused by a drill during implant surgery.

### Technical Solution

In order to accomplish the above object, the present invention provides a stent for implant surgery, including a support part surrounding a buccal side, lingual side and occlusal side of at least one tooth, and a treated part having a through hole through which a drill for drilling alveolar bone passes, wherein the support part extends further from a height of a contour of at least one of the buccal side and the lingual side to surround part of an undercut of the tooth, and an elastic part which is elastically deformable is attached to an inner surface of each of the buccal side and the lingual side of the support part.

The elastic modulus of the elastic part is higher than that of the support part, and the elastic part is made of a silicone material.

Further, in order to prevent the removal of the elastic part, the stent further includes a projection provided on the lower end of each of the buccal side and the lingual side of the support part. Each of the buccal side and the lingual side of the support part further includes a removal prevention hole charged with the elastic part.

Meanwhile, the occlusal side of the support part has a discharge hole to discharge surplus elastic part to an outside.

Each of the support part and the treated part is made of fiber reinforced plastics or carbon fiber.

Further, a guide bushing is embedded into the through hole of the treated part, and includes a guide surface having a circular cross-section, so that the guide surface contacts an outer surface of a shank of the drill for drilling the alveolar bone and guides the drill. The guide bushing has a circular cylindrical shape or an elliptical cylindrical shape.

Further, at least one fixing base having a truncated conical shape is embedded into the support part and/or the treated part, a through hole being formed in a longitudinal direction of the fixing base so that a fixing screw inserted into the alveolar bone to fix the stent passes through the through hole of the fixing base.

### ADVANTAGEOUS EFFECTS

According to the present invention, a stent for implant surgery is constructed so that a support part surrounding the buccal side, lingual side and occlusal side of a tooth extends further from the height of the contour of at least one of the buccal side and the lingual side to surround part of the undercut of the tooth, and an elastic part which is elastically deformable is attached to the inner surface of each of the buccal and lingual sides of the support part. Thus, the elastic deformation of the elastic part allows the stent to be smoothly detached from or attached to teeth, and the elastic part which contracts while passing the height of contour of the teeth is elastically restored at the undercut, so that the undercut underneath the height of the contour is in close contact with the inner surface of the stent via the elastic part, thus securing the stent more reliably to the teeth. Moreover, vibrations caused by a drill during implant surgery are absorbed by the inherent elasticity of the elastic part, so that the stent is maintained at a predetermined position even during the drilling operation.

### DESCRIPTION OF DRAWINGS

FIG. 1 is a perspective view schematically illustrating a conventional stent for implant surgery and a patient's teeth covered with the stent;

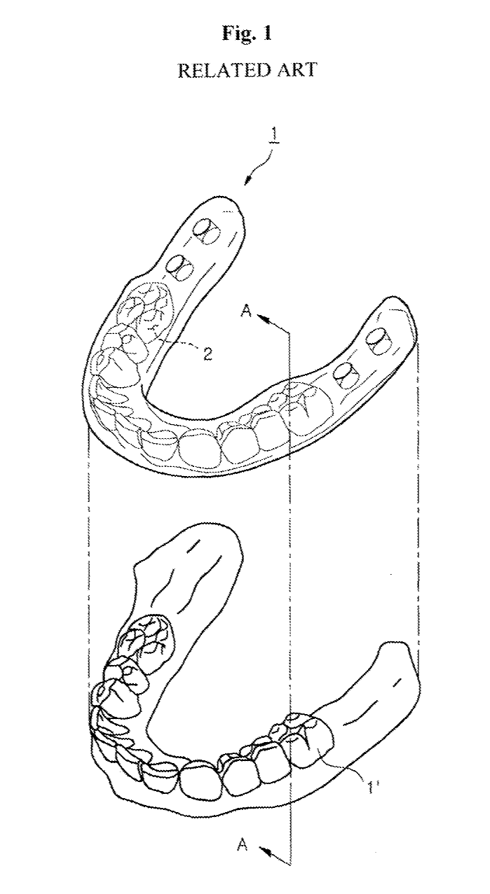

FIG. 2 is a sectional view taken along line A-A when the stent for the implant surgery of FIG. 1 is coupled to the teeth;

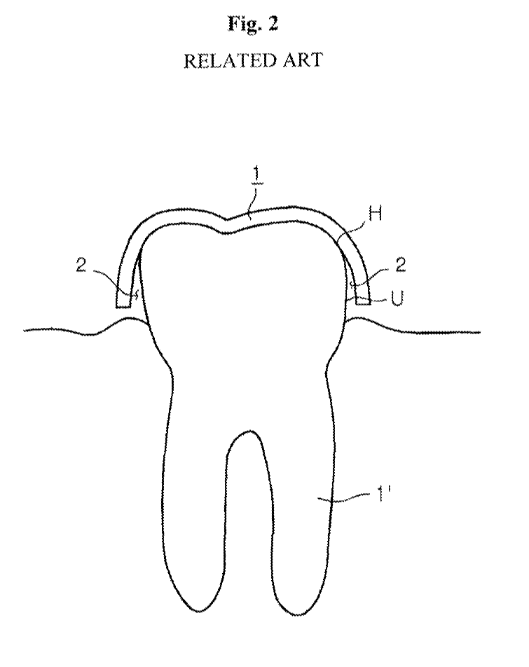

FIG. 3 is a perspective view schematically illustrating a stent for implant surgery according to the present invention and a patient's teeth covered with the stent;

FIG. 4 is a sectional view taken along line B-B when the stent for the implant surgery of FIG. 3 is coupled to the teeth;

FIG. 5 is a sectional view taken along line B-B when the stent for the implant surgery of FIG. 3 is coupled to the teeth, in which a projection is formed on the lower end of each of the buccal side and the lingual side of a support part;

FIG. 6 is a sectional view taken along line C-C when the stent for the implant surgery of FIG. 3 is coupled to the teeth;

FIG. 7 is a sectional view taken along line D-D when the stent for the implant surgery of FIG. 3 is coupled to the teeth;

FIG. 8 is a perspective view illustrating a guide bushing having a circular cylindrical shape which is embedded into a through hole in the stent for implant surgery according to the present invention;

FIG. 9 is a perspective view illustrating a guide bushing having an elliptical cylindrical shape which is embedded into the through hole in the stent for implant surgery according to the present invention; and

FIG. 10 is a perspective view illustrating a fixing base having the shape of a truncated cone which is embedded into the support part of the stent for implant surgery according to the present invention or embedded into a treated part.

### BEST MODE

Hereinafter, the preferred embodiment of the present invention will be described in detail with reference to the accompanying drawings.

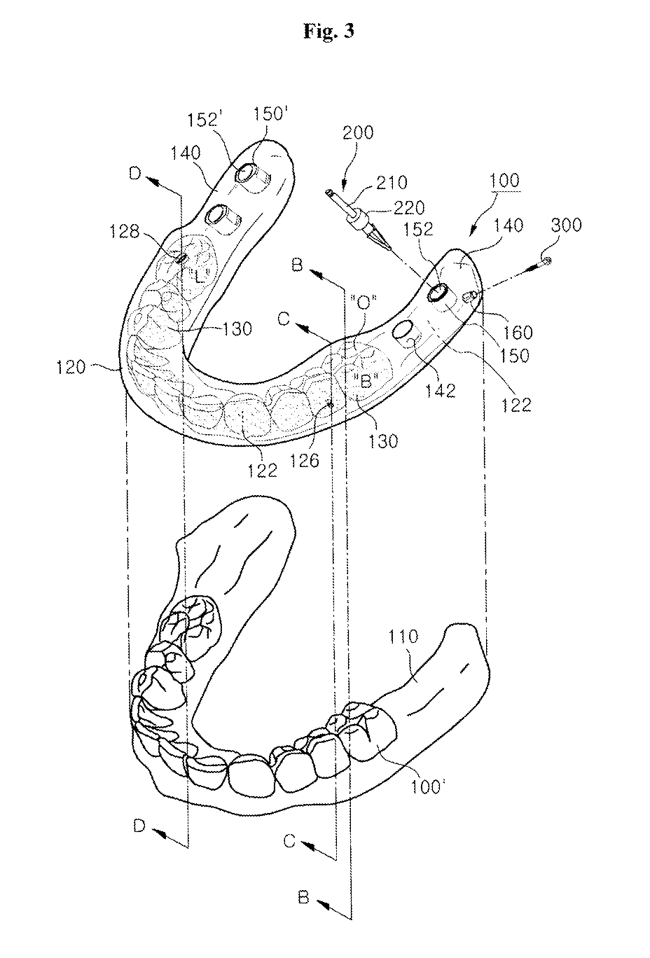

FIG. 3 is a view schematically illustrating a stent 100 for implant surgery according to the present invention and teeth 100′ (or a tooth mold based on the teeth) to which the stent 100 is detachably attached.

The stent 100 for implant surgery according to the present invention includes a support part 120 and a treated part 140. The support part surrounds the buccal side B, lingual side L and occlusal side O of at least one tooth 100′. A through hole is formed in the treated part so that a drill 200 for drilling alveolar bone passes through the through hole. Here, the support part 120 extends further from the height of the contour H of at least one of the buccal side B and the lingual side L to surround part of the undercut U of the tooth 100′. Particularly, an elastic part 130 which is elastically deformable is attached to the inner surface of each of the buccal side B and the lingual side L of the support part 120.

The support part 120 designates the part which supports the whole portion of the stent 100 at a predetermined position on the tooth 100′. As described above, the stent 100 for the implant is manufactured by making a mold in accordance with the dental shape of a patient, applying transparent resin such that it surrounds the gum 110 from which a tooth is missing and a proper number of teeth 100′, and thereafter hardening the resin. Hence, the support part 120 has a cavity which has the same shape as that of the tooth 100′ to which the resin is applied. Thus, when the cavity covers the corresponding shape of a tooth 100′, the support part 120 surrounds the buccal side B, the lingual side L and the occlusal side O of the tooth 100′. Here, it is determined how many teeth 100′ are surrounded with the stent 100, namely, how many cavities are formed in the stent 100, in consideration of the support ability of the stent 100. Thus, the number of cavities is not equal in all cases. In addition to the stent 100 surrounding a whole set of teeth as shown in FIG. 3, a stent which is shaped to surround only a molar or a premolar but not a front tooth may be used.

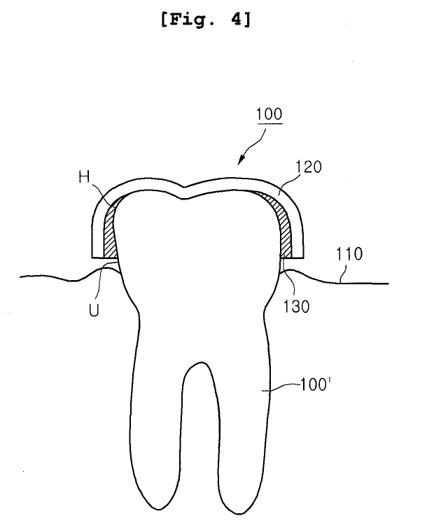

According to the most important characteristic of the present invention, the elastic part 130 which is elastically deformable is attached to the inner surface of each of the buccal side B and the lingual side L, except for the occlusal side O of the support part 120. FIG. 4 is a sectional view taken along line B-B of FIG. 3 when the stent 100 and the teeth 100′ are coupled to each other. As shown in FIG. 4, the undercut U underneath the height of the contour H of a tooth 100′ and the inner surface of the stent 100 are in close contact with each other via the elastic part 130. The elastic part 130 is made of a material which is easily elastically deformed, for example, a silicone material. The elastic part 130 is constructed so that its elastic modulus is higher than that of the support part 120.

Thus, while the stent 100 is being attached to or detached from the teeth 100′, the elastic part 130 is elastically deformed prior to the elastic deformation of the support part 120. Thus, the elastic deformation of the support part 120 is minimized, and the stent 100 is smoothly detachably attached to the teeth 100′. Further, when the stent 100 has been completely attached to the teeth 100′, namely, when the occlusal side O of the support part 120 comes into contact with the occlusal surface of the teeth 100′, the elastic part 130 is elastically restored, thus filling a gap between the undercut U underneath the height of the contour H of the teeth 100′ and the inner surface of the stent 100, and therefore allowing the stent 100 to be in close contact with the teeth. The elastic part 130 contributes to maintaining the support ability of the stent 100 in the dynamic state as well as in the static state. This is because the inherent elasticity of the elastic part 130 absorbs vibrations caused by the drilling operation of the drill 200.

Further, the treated part 140 designates the part having the through hole through which the drill 200 for drilling the alveolar bone passes. Since the treated part is the part formed by applying the resin to the gum 110 from which a tooth is missing and hardening the resin during the manufacturing process of the stent 100, the treated part has no construction similar to the cavity formed in the support part 120. The treated part 140 is made depending on a portion in which a tooth is missing from among the set of teeth of a patient, so that the treated part may be provided on any portion of the stent 100 including the middle portion or end of the stent.

The support part 120 and the treated part 140 may be made of fiber reinforced plastics or carbon fiber, in addition to transparent resin. Glass fiber, carbon fiber or kevlar is used as the reinforcing material of the fiber reinforced plastics.

The stent 100 for implant surgery according to the present invention may have the construction for more effectively preventing the removal of the elastic part 130 due to the repeated attachment and detachment of the stent.

The basic force attaching the elastic part 130 to the inner surface of each of the buccal side B and the lingual side L of the support part 120 is the adhesive force of the elastic part 130. Silicone is the preferred material to be used for the elastic part 130, in consideration of the adhesive force as well as the elastic restoring force.

However, the adhesive force of the elastic part 130 may be insufficient for preventing the elastic part 130 from dislodging from its original position, due to the repetitive use of the stent. The present invention provides two additional constructions for preventing the removal of the elastic part 130.

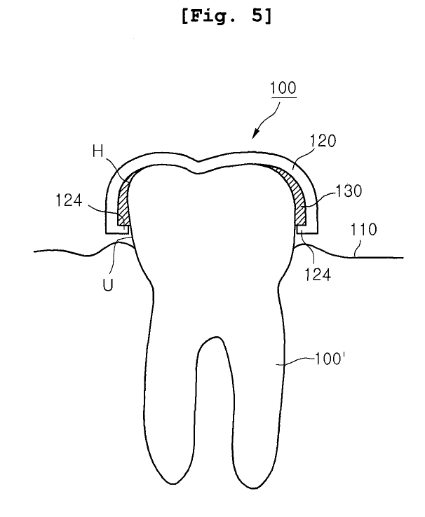

One of the constructions is to form the projection 124 on the lower end of each of the buccal side B and lingual side L of the support part 120. FIG. 5 is a sectional view taken along line B-B of FIG. 3 when the stent for the implant is coupled to the teeth, in which the projection is formed on the lower end of each of the buccal side B and lingual side L of the support part. It can be intuitively seen that the elastic part 130 is fitted between an end of the occlusal side O and the projection 124, so that the projection 124 effectively prevents the elastic part 130 from dislodging from its original position.

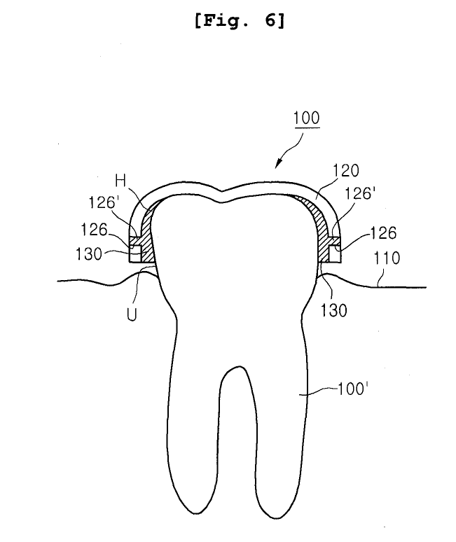

The other construction is to form a removal prevention hole 126 in each of the buccal side B and lingual side L of the support part 120. FIG. 6 is a sectional view taken along line C-C of FIG. 3 when the stent 100 and the teeth 100′ are coupled to each other. It should be noted that even the inner portion of the removal prevention hole 126 is charged with the elastic part 130. If the elastic part 130 is made of a silicone material having some fluidity before it is hardened, even the inner portion of the removal prevention hole 126 may be charged with silicone while the silicone material is applied to the inner surface of each of the buccal side B and the lingual side L of the support part 120 so as to form the elastic part 130. After the fluidity of the silicone disappears, the elastic part 130 has an arm 126′ which extends into the removal prevention hole 126. Thus, the completed elastic part 130 is more firmly held by the adhesive force between the atm 126′ and the inner surface of the removal prevention hole 126. Further, the arm 126′ resists even the shearing force which is generated when the elastic part 130 tries to move up and down, so that the support ability of the elastic part 130 is more reliably ensured.

Meanwhile, the elastic part 130 is not included in the occlusal side O of the support part 120. This is because a clearance is formed to fix the stent 100 in a vertical direction if the elastically moving elastic part 130 is provided on the occlusal side O. Thus, in any case, the elastic part 130 must not be provided on the occlusal side O of the support part 120. However, when the elastic part 130 is formed, some resin is further applied in excess to each of the buccal side B and the lingual side L of the support part 120. Thus, the surplus resin may be pushed up and enter the occlusal side O.

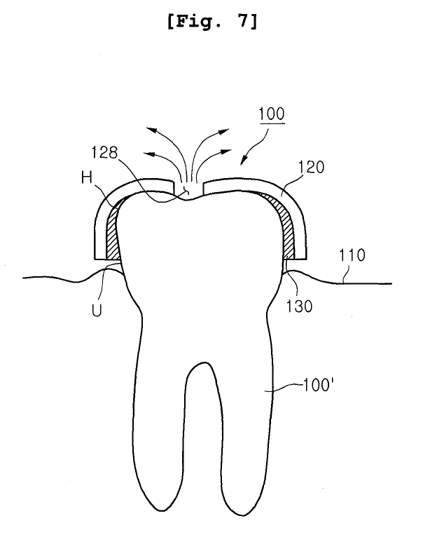

FIG. 7 is a sectional view taken along line D-D of FIG. 3 when the stent 100 and the teeth 100′ are coupled to each other. A discharge hole 128 is further formed in the occlusal side O of the support part 120 to discharge surplus elastic part 130 to the outside. Preferably, the discharge hole 128 is formed at a position corresponding to the concave portion of the occlusal surface of a tooth.

Here, it should be understood that FIG. 3 shows the preferred embodiment and respective modifications of the stent 100 for implant surgery according to the present invention. That is, the drawing shows a construction which may have all of the projection 124, the removal prevention hole 126 and the discharge hole 128. In other words, the projection 124, the removal prevention hole 126 and the discharge hole 128 need not be separately provided. It should be noted that the three constructions are used in combination as necessary.

Hereinbefore, the construction of the support part 120 of the stent 100 according to the present invention has been mainly described. In addition to the characteristic construction of the support part 120, the present invention may include other technical characteristics.

The first characteristic pertains to the through hole of the treated part 140. The through hole is the hole in and out which the drill 200 for drilling the alveolar bone moves, and is formed to be slightly larger than the outer diameter of the drill 200. Conventionally, the through hole serves as only the entrance of the drill 200, but never guides the drilling direction of the drill 200.

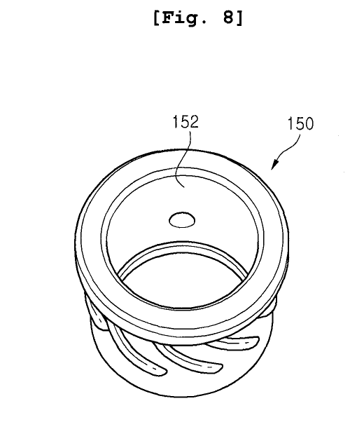

In order to solve the problem, the stent 100 for implant surgery according to the present invention is constructed so that a guide bushing 150 having a circular cylindrical shape, as shown in FIG. 8, is embedded into the through hole of the treated part 140 so as to guide the drilling direction of the drill 200 for drilling the alveolar bone (see FIG. 3). A guide surface 152 having a circular cross-section is formed through the guide bushing 150 so that the guide surface is in contact with the outer surface of the shank 210 of the alveolar bone drill 200 and guides the drill in an accurate drilling direction.

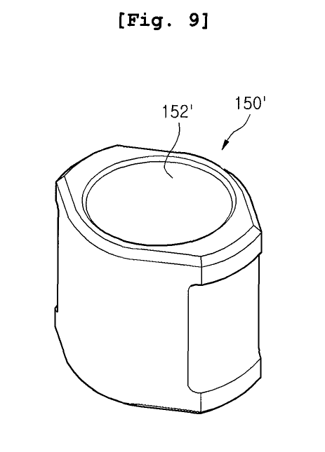

Further, another embodiment of the guide bushing is illustrated in FIG. 9. The guide bushing 150′ of FIG. 9 has an elliptical cylindrical shape. The guide bushing 150′ having the elliptical cylindrical shape is advantageous in that the guide bushing 150′ secured to the stent 100 has an elliptical cross-section when viewed from a direction perpendicular to the drilling direction of the drill 200, thus preventing the guide bushing 150′ from rotating together with the drill 200, even though the drill 200 rotates at high speed while being guided along a guide surface 152′.

The guide bushing 150 or 152′ fundamentally functions to guide the drilling direction of the drill 200. If a cylindrical guide part 220 having the outer diameter which is larger than the diameter of the drill 200 is provided at a proper position of the shank 210, and a stopper is provided on the lower end of the guide surface 152 or 152′ of the guide bushing 150 or 150′ or the upper surface of the guide part 220, it is possible to control a drilling depth. That is, if the position of the guide part 220 of the drill 200 is appropriately selected, and the stopper for preventing the guide part 220 from moving forwards any more is provided on the lower end of the guide surface 152 or 152′ of the guide bushing 150 or 150′ or the upper surface of the guide part 220, the forward movement of the drill 200 is permitted only until the lower surface of the guide part 220 comes into contact with the stopper of the guide bushing 150 or 150′, or until the stopper of the guide part 220 comes into contact with the upper surface of the guide bushing 150 or 150′, so that the drilling depth is limited. As an example of the stopper shape, a projection may be provided on the lower end of the guide surface 152 or 152′ of the guide bushing 150 or 150′, and a disc-shaped projection may protrude diametrically from the upper surface of the guide part 220 of the drill 200.

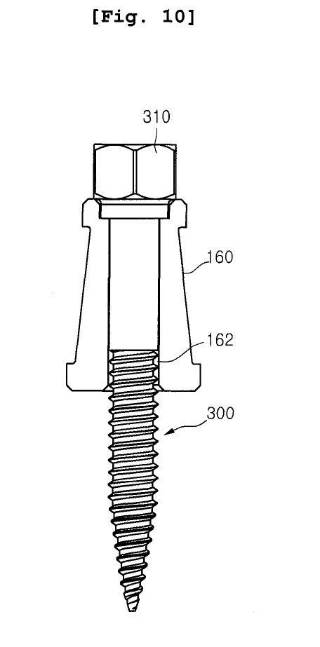

Further, in addition to the characteristic construction of the support part 120, the stent 100 for implant surgery according to the present invention has the following characteristics. That is, as shown in FIG. 10, at least one fixing base 160 having a truncated cone shape may be embedded into the support part 120 and/or the treated part 140. A through hole 162 is formed in the longitudinal direction of the fixing base 160. A fixing screw 300 for more firmly fixing the stent 100 into a patient's mouth passes through the through hole 162 and is screwed to the alveolar bone (see FIG. 3). The fixing screw 300 is used to obtain the support force of the stent 100 from the alveolar bone when the state of a patient's teeth is considerably bad or the number of teeth for supporting the stent 100 is excessively lacking. The fixing base 160 embedded into the stent 100 according to the present invention is compressed between the gum 110 and the head 310 of the fixing screw, and is placed such that the wide lower surface of the truncated cone contacts the gum 110. The placement compresses the fixing screw 300, thus preventing the fixing base 160 from being removed from the stent 100.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

As described above, the present invention provides a stent for implant surgery, which allows drilling work for implant surgery to be more precisely and effectively performed.

1. A stent for implant surgery, including a support part surrounding a buccal side, lingual side and occlusal side of at least one tooth, and a treated part having a through hole through which a drill for drilling alveolar bone passes, wherein the support part extends further from a height of a contour of at least one of the buccal side and the lingual side to surround part of an undercut of the tooth, and an elastic part which is elastically deformable is attached to an inner surface of each of the buccal side and the lingual side of the support part.

2. The stent according to claim 1, wherein an elastic modulus of the elastic part is higher than that of the support part.

3. The stent according to claim 1, wherein the elastic part is made of a silicone material.

4. The stent according to claim 1, further comprising:
a projection provided on a lower end of each of the buccal side and the lingual side of the support part.

5. The stent according to claim 1, wherein each of the buccal side and the lingual side of the support part further comprises a removal prevention hole charged with the elastic part.

6. The stent according to claim 1, wherein the occlusal side of the support part comprises a discharge hole to discharge surplus elastic part to an outside.

7. The stent according to claim 5, wherein the occlusal side of the support part comprises a discharge hole to discharge surplus elastic part to an outside.

8. The stent according to claim 1, wherein each of the support part and the treated part is made of fiber reinforced plastics or carbon fiber.

9. The stent according to claim 1, wherein a guide bushing is embedded into the through hole of the treated part, and comprises a guide surface having a circular cross-section, so that the guide surface contacts an outer surface of a shank of the drill for drilling the alveolar bone and guides the drill.

10. The stent according to claim 9, wherein the guide bushing has a circular cylindrical shape.

11. The stent according to claim 9, wherein the guide bushing has an elliptical cylindrical shape.

12. The stent according to claim 1, wherein at least one fixing base having a truncated conical shape is embedded into the support part and/or the treated part, a through hole being formed in a longitudinal direction of the fixing base so that a fixing screw inserted into the alveolar bone to fix the stent passes through the through hole of the fixing base.

13. The stent according to claim 2, wherein the elastic part is made of a silicone material.

14. The stent according to claim 4, wherein each of the buccal side and the lingual side of the support part further comprises a removal prevention hole charged with the elastic part.

15. The stent according to claim 4, wherein the occlusal side of the support part comprises a discharge hole to discharge surplus elastic part to an outside.

16. The stent according to claim 14, wherein the occlusal side of the support part comprises a discharge hole to discharge surplus elastic part to an outside.
